(19) United States
(12) Patent Application Publication
(10) Pub. No.: US 2011/0044773 A1
(43) Pub. Date: Feb. 24, 2011

(54) CYLINDRICAL CUTTER

(75) Inventors: Jürgen Seidel, Kreuztal (DE); Peter Sudau, Hilchenbach (DE); Jürgen Merz, Kreuztal (DE); Matthias Kipping, Herdorf (DE)

Correspondence Address: COHEN, PONTANI, LIEBERMAN & PAVANE LLP, 551 FIFTH AVENUE, SUITE 1210, NEW YORK, NY, 10176, US

(73) Assignee: SMS Slemag AG, Dusseldorf (DE)

(21) Appl. No.: 12/532,045

(22) PCT Filed: Feb. 11, 2008
(86) PCT No.: PCT/DE2008/000265

§ 371 Date: Mar. 29, 2010

(30) Foreign Application Priority Data
Mar. 21, 2007 (DE) 10 2007 014 262.7

(51) Int. Cl. B23C 5/04; B23C 5/20

(52) U.S. Cl. 407/31; 407/47; 407/119

(57) ABSTRACT

The invention is directed to a cylindrical milling cutter whose cylindrical body is provided with grooves which extend along its length at a distance from one another and at an angle to the longitudinal axis, and indexable cutting inserts, particularly coated carbide cutting inserts, are arranged in these grooves. For substantially preventing axial forces acting on the milling cutter or on the material to be machined, it is proposed either that the grooves and therefore the knife edges of the indexable cutting inserts are portionally oriented at different angles, these angles being selected such that the axial forces occurring in one portion during the machining process are neutralized or reduced in a defined manner by the axial forces occurring in the adjacent portion, or that the indexable cutting inserts are alternately arranged or oriented in the grooves in such a way that the axial force caused by one indexable cutting insert during the machining process is neutralized by the axial force caused by the adjacent indexable cutting insert.

### PRIORITY CLAIM

This is a U.S. national stage of Application No. PCT/DE2008/000265, filed on 11 Feb. 2008, which claims Priority to the German Application No. 10 2007 014 262.7, filed: 21 Mar. 2007 the contents of both being incorporated herein by reference.

### BACKGROUND OF THE INVENTION

1. Field of the Invention

The invention is directed to a cylindrical milling cutter outfitted with indexable cutting inserts, particularly coated carbide cutting inserts.

2. Prior Art

Cylindrical milling cutters used for machining nonferrous metal strips or sheets are known.

DE20204478 U1 describes a cylindrical milling cutter on which helical grooves are formed in which helix blades (HSS blades) with quasi-continuous knife edges are arranged, one behind the other, and are held by wedges and screws.

For a more economical machining process, DE 29913164 U1 describes indexable carbide cutting inserts for cylindrical milling cutters such as are known for porcupine cutters. It is advantageous that the cutting inserts do not have to be sharpened on relatively expensive grinding machines and are utilized more efficiently by turning the cutting inserts, i.e., 4 or 8 knife edges of the insert can be used.

Both types of cylindrical milling cutters have knife edges that are arranged helically over a barrel length at a circumference of the milling cutter. Further, the cutting inserts are inclined at an angle, e.g., 10° relative to the axis of rotation. As is known, this inclined arrangement provides a smoother initial cutting and, generates a smaller dynamic load on the cylindrical milling cutter and therefore on the entire machine. This also reduces the vibrations excited during the machining process.

However, owing to the inclined arrangement of the knife edges, the machining force generates a force component in an axial direction. This loads axial bearings of the cylindrical milling cutter and leads to shear forces in the slab or strip to be machined that are absorbed in the lateral guides. Accordingly, the shear force also has a negative impact on the running of the strip, particularly at the head and end of the strip, where the lateral guide does not act in front of and behind the milling cutter. This occurs especially with wider strip, higher reductions, or higher-strength materials.

### SUMMARY OF THE INVENTION

It is an object of the invention to provide a cylindrical milling cutter by which axial forces acting on the milling cutter or on the material to be machined are substantially prevented.

In a cylindrical milling cutter, whose cylindrical body is provided with grooves that extend along its length at a distance from one another and at an angle to the longitudinal axis, indexable cutting inserts, particularly coated carbide cutting inserts, are arranged in these grooves. The grooves, and therefore the knife edges, of the indexable cutting inserts are oriented at different angles. The angles are selected such that the axial forces occurring in one portion during the machining process are neutralized by the axial forces occurring an adjacent portion, or are reduced in a defined manner.

Alternatively, the cylindrical milling cutter whose cylindrical body is provided with grooves, which extend along its length at a distance from one another and at an angle to the longitudinal axis, indexable cutting inserts, particularly coated carbide cutting inserts, are arranged in these grooves. The indexable cutting inserts are alternately arranged or oriented in the grooves such that the axial force caused by one indexable cutting insert during the machining process is neutralized by the axial force caused by an adjacent indexable cutting insert.

In general, the effect can also be expressed mathematically by the following equation:

$${\sum }_{i = 1}^{n} ( {L}_{i} \times {α}_{i} ) \approx 0 ,$$

where:

i=knife edge index

n=quantity of knife edges along the length of the milling cutter

Lᵢ=length of the knife edge i

αᵢ=angle of inclination of the knife edge i

The angle of inclination α, the orientation of the knife edge, is positive or negative, and changes over the length of the milling cutter.

According to one embodiment, the grooves and knife edge orientation extend mirror-symmetrically with respect to a transverse plane through the cylindrical body.

The cylindrical body comprises disks that are arranged in succession axially and which are held together by clamping elements so that in every two adjacent disks the grooves and, therefore, the knife edge orientations extend mirror-symmetrically with respect to a separating plane between the disks.

In one embodiment a plurality of indexable cutting inserts are assembled blockwise on a holding plate and that the individual holding plates with the knife edges secured thereto are secured to the cylindrical body so as to be variously oriented. The orientation is carried out in substantially the same way as previously described for the individual indexable cutting inserts.

The sum of the product of the length of the knife edge and the angle of inclination of all of the knife edges of the cylindrical milling cutter should equal zero.

A defined small axial force is generated in that the arrangement of the knife edges is selected to be slightly different in the positive direction compared to the negative direction, or in that the quantity of knife edges with a positive inclination is somewhat higher than the quantity of knife edges with a negative inclination.

The orientation of the knife edges of the indexable cutting inserts extend in an arrow-shaped or arc-shaped convex or concave line or zigzag line as viewed from the front of the cylindrical milling cutter.

The invention is directed to a cylindrical milling cutter which is outfitted with indexable cutting inserts, particularly coated carbide cutting inserts. However, in contrast to the prior art, the indexable cutting inserts in the invention are oriented so that the axial forces that occur during the machining process and which would act on the cutting cylinder and on the material to be machined are nonexistent or, at most, minimal or of a defined smallness.

### BRIEF DESCRIPTION OF THE DRAWINGS

In the drawings:

FIG. 1 is a schematic view of a cylindrical milling cutter with indexable cutting inserts arranged according to the invention;

FIG. 2 a-c are three different examples for the arrangement of the indexable cutting inserts;

FIG. 3 is a disk-shaped construction of a cylindrical milling cutter;

FIG. 4 is a modified construction referring to FIG. 1; and

FIG. 5 are different knife edge constructions.

### DETAILED DESCRIPTION OF THE DRAWINGS

According to a construction shown in FIG. 1, the cylindrical milling cutter comprises a cylindrical body 1 with grooves 2 that are incorporated in a helical manner for both halves of the cylinder over the entire circumference of the cylinder in which indexable cutting inserts 3 are fastened. Details concerning the fastening or bearing support, of the cylinder, etc. are not shown since they are not essential to understand the present invention. The knife edges of the indexable cutting inserts are arranged and oriented in a somewhat arrow-shaped manner in this construction. Because of the symmetrical arrangement, i.e., the arrangement of the knife edges on the left and on the right of a longitudinal centerline of the cylinder, the axial force components are canceled so that the axial force is minimal, zero in exceptional cases. Guides for the strip within the milling cutter are configured in a simple manner within a smaller installation space and are not as highly loaded. Further, flying chips are directed approximately to the side i.e., longitudinal ends of the cylinder, in this construction, which is beneficial for chip removal at the top. Also, the diagonal, offset arrangement of the knife edges provides a smooth initial cut.

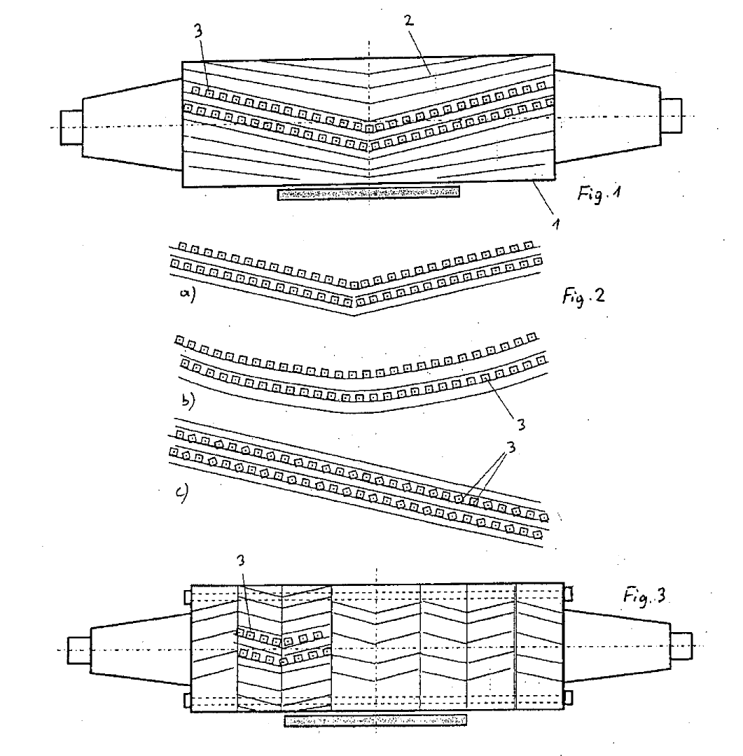

Alternative arrangements and orientations of the knife edges are shown in FIG. 2. Example a) corresponds to the construction according to FIG. 1 and is only shown here to facilitate understanding of the construction according to Example b). In an alternative embodiment form b), the knife edges are arranged in an arc shape as viewed from the front.

Depending on the desired path of the chips, the arrangement of the cutting inserts according to a) and b) can have a concave or convex configuration, i.e., the knife edges of one row, e.g., in the middle of the milling cutter, run into the machining area first or, in case of a different direction of curvature, run into the machining area last. Depending on the embodiment form, the chips then fly outward toward the edge of the slab or inward toward the middle of the slab.

Example c) corresponds to the embodiment form known from the prior art with respect to the arrangement of the cutting inserts. However, every second carbide knife edge is oriented differently.

In the construction of a cylindrical milling cutter shown in FIG. 3, the cylindrical body comprises individual disks, whose pitch direction is altered in an alternative construction.

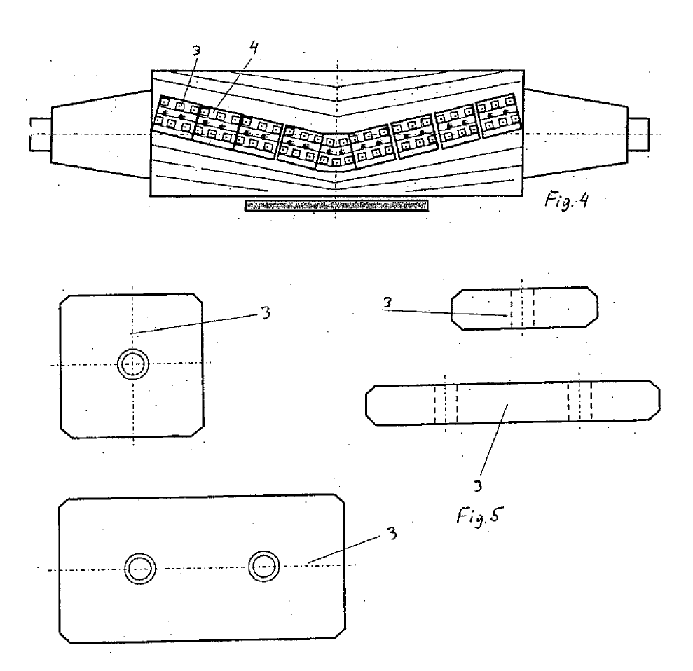

Another advantageous construction of a cylindrical milling cutter is shown in FIG. 4. In this case, carbide indexable cutting inserts are held together blockwise in holding plates 4 (cartridges). These holding plates are in turn mounted on the base body in such a way that the orientation of the knife edges is arrow-shaped, for example, as has already been shown.

In the embodiment examples, two rows of knife edges are shown in more detail. The overlap of the offset arrangement of the knife edges can be seen. A plurality of double rows are arranged in the same manner over the entire circumference.

The constructional shapes mentioned above (cylindrical milling cutter comprising one part, cylindrical milling cutter composed of disks, cylindrical milling cutter with knife edge holding plates) are constructed with a combination of the different knife edge arrangements.

For the sake of completeness, the indexable cutting inserts shapes that can be used are shown in FIG. 5. A radial arrangement and a tangential arrangement of the cutting inserts are both provided for the cylindrical milling cutter. In an advantageous manner, the inserts are constructed so as to be square or rectangular with an edge interruption. Coated carbide cutting inserts, indexable cutting inserts, are preferably used.

As was already explained, the aim in all of the constructional shapes by means of the described arrangement and orientation of the knife edges is to maintain minimal machining forces in axial direction during the machining process and to make possible a smooth penetration of the knife edge into the workpiece (slab) at the same time. As an alternative to the aim of achieving zero axial force, a defined small axial force and direction of axial force can also be adjusted. This can be achieved in an advantageous manner in that the arrangement of the knife edges facing toward one side is altered slightly to incline toward the other side, or, alternatively, in that the quantity of knife edges with a negative inclination is somewhat higher than the quantity of knife edges with a positive inclination.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. Cylindrical milling cutter whose cylindrical body is provided with grooves which extend along its length at a distance from one another and at an angle to the longitudinal axis, indexable cutting inserts, particularly coated carbide cutting inserts, being arranged in these grooves, characterized in that the grooves and therefore the knife edges of the indexable cutting inserts are portionally oriented at different angles, these angles being selected in such a way that the axial forces occurring in one portion during the machining process are neutralized by the axial forces occurring in the adjacent portion or are reduced in a defined manner.

2. Cylindrical milling cutter whose cylindrical body is provided with grooves which extend along its length at a distance from one another and at an angle to the longitudinal axis, indexable cutting inserts, particularly coated carbide cutting inserts, being arranged in these grooves, characterized in that the indexable cutting inserts are alternately arranged or oriented in the grooves in such a way that the axial force caused by one indexable cutting insert during the machining process is neutralized by the axial force caused by the adjacent indexable cutting insert.

3. Cylindrical milling cutter according to claim 1, characterized in that the knife edge orientation extends mirror-symmetrically with respect to a transverse plane through the cylindrical body.

4. Cylindrical milling cutter according to one of the preceding claims, characterized in that the cylindrical body comprises disks which are arranged in succession axially and which are held together by clamping elements, and in that the grooves and, therefore, the knife edge orientations in every two adjacent disks extend mirror-symmetrically with respect to the separating plane between the disks.

5. Cylindrical milling cutter according to one of the preceding claims, characterized in that a plurality of indexable cutting inserts are assembled blockwise on a holding plate, and the individual holding plates with the knife edges secured thereto are secured to the cylindrical body so as to be variously oriented.

6. Cylindrical milling cutter according to one of the preceding claims, characterized in that the sum of the product of the length of the knife edge and the angle of inclination of all of the knife edges of the milling cylinder is equal to zero.

7. Cylindrical milling cutter according to one of the preceding claims, characterized in that a defined small axial force is generated in that the arrangement of the knife edges is selected so as to be slightly different in the positive direction compared to the negative direction, or in that the quantity of knife edges with a positive inclination is somewhat higher than the quantity of knife edges with a negative inclination.

8. Cylindrical milling cutter according to claim 1, characterized in that the orientation of the knife edges extends in an arrow-shaped or arc-shaped convex or concave line or zigzag line viewed from the front.
